(19) United States
(12) Patent Application Publication
(10) Pub. No.: US 2025/0130749 A1
(43) Pub. Date: Apr. 24, 2025

(54) SMART DISPLAY DEVICE DISPLAYING AN APPEARANCE OF A TRANSPORTATION VEHICLE, SETTING METHOD, METHOD OF USE, AND NON-TRANSITORY COMPUTER-READABLE RECORDING MEDIUM THEREOF

(71) Applicant: COMPAL ELECTRONICS, INC., Taipei (TW)

(72) Inventors: TING-WEI WU, Taipei (TW); MING-HSIEN WU, Taipei (TW)

(73) Assignee: COMPAL ELECTRONICS, INC., Taipei (TW)

(21) Appl. No.: 18/895,428

(22) Filed: Sep. 25, 2024

Related U.S. Application Data
(60) Provisional application No. 63/545,211, filed on Oct. 23, 2023.
(60) Provisional application No. 63/601,762, filed on Nov. 22, 2023.

(51) Int. Cl. G06F 3/14; B60K 35/21; B60K 35/29; G06F 3/04845

(52) U.S. Cl. CPC G06F 3/14; B60K 35/21; B60K 35/29; B60K 2360/186; G06F 3/04845

(57) ABSTRACT

A smart display device displaying an appearance of a transportation vehicle comprises a display element, a user interface, and a smart display device. The display element is located in multiple regions along a contour of a vehicle body. The user interface includes a status display region and a function display region, a user defines electronic display contents in the function display region according to preferences, and previews the electronic display contents in the status display region. The electronic display contents include a background and text and/or patterns displayed on the background. The smart display device determines the electronic display contents according to the operation of the user interface to display the electronic display contents on the display element in real-time. The invention also provides a setting method, a method of use, and a non-transitory computer-readable recording medium thereof.

### CROSS-REFERENCE TO RELATED APPLICATION

This non-provisional application claims priority under 35 U.S.C. § 119 (e) on U.S. provisional Patent Application Nos. 63/545,211 and 63/601,762, filed on Oct. 23, 2023 and Nov. 22, 2023, respectively, the entire contents of which are hereby incorporated by reference.

### BACKGROUND OF THE INVENTION

### 1. Field of the Invention

The present disclosure relates to a technique for changing display contents of a vehicle body of a transportation vehicle, and in particular to a smart display device displaying an appearance of a transportation vehicle, and a setting method, a method of use and a non-transitory computer-readable recording medium thereof.

### 2. Description of the Related Art

The appearance of a main body of an existing vehicle is usually based on the shape of a vehicle body and then presented in coordination with a painted vehicle color, or even further sprayed or transferred with a pattern. At this point in time, the appearance of the main body is substantially fixed. Although the appearance of the main body can be changed by altering the pattern or by repainting, such process is time- and labor-consuming and quick adjustment cannot be achieved. Moreover, signs that can be displayed by an existing vehicle, such as left turn, right turn and rear warning, are all constructed in the form of physical lamps, and are displayed in a manner of normally on and/or flashing. In addition to an issue of poor identification due to insufficient ambient light or aging of lamps, restrictions in terms of arrangement positions of physical lamps on a vehicle and volumes of physical lamps not only disfavor designs of an appearance of a vehicle, but also make it infeasible to provide customized real-time display according to user requirements or preferences.

Therefore, it is an object of the present disclosure to provide a solution for solving the above issues of the prior art.

### BRIEF SUMMARY OF THE INVENTION

To overcome the issues above, the applicant provides a smart display device displaying an appearance of a transportation vehicle, and a setting method, a method of use and a non-transitory computer-readable recording medium thereof, so that the appearance of the transportation vehicle can be customized and displayed in real time.

To achieve the objects above, the present disclosure provides a smart display device displaying an appearance of a transportation vehicle to allow an appearance of a vehicle body of the transportation vehicle to be customized and displayed in real time. The smart display device includes a display element, a user interface and a smart display unit. The display element is disposed in multiple regions of the vehicle body along a contour of the vehicle body. The user interface includes a state display region for previewing display contents, and a function display region for setting the display contents. A user defines electronic display contents in the function display region according to preferences, and previews the electronic display contents in real time in the state display region. The electronic display contents include a background, and a text and/or a pattern displayed in the background. The smart display unit is electrically connected to the display element and the user interface, and determines the electronic display contents according to an operation of the user interface, so as to display the electronic display contents as the appearance of the vehicle body in real time on the display element.

In one embodiment, the transportation vehicle is a vehicle with two or more

wheels, the vehicle body is a vehicle body of the vehicle, the multiple regions include a vehicle front portion, a first side portion, a second side portion and a vehicle rear portion, the display element is one or more and disposed conformably along contours of the first side portion, the second side portion and the vehicle rear portion, and the electronic display contents can be displayed separately or displayed integrally at the first side portion, the second side portion and/or the vehicle rear portion.

In one embodiment, the smart display unit receives a display signal according to a direction of travel, a real-time position and/or a state of travel of the transportation vehicle at a current timing from the transportation vehicle and/or an exterior, and the electronic display contents are contents corresponding to the direction of travel, the real-time position and/or the state of travel displayed by the display element in at least one of the regions according to the display signal.

In one embodiment, the smart display unit includes an image processing module and a smart identification module, the image processing module is operable to receive the display signal and decode/encode the same to provide the electronic display contents to the display element, and the smart identification module is operable to identify and differentiate a display range of the display element in each of the regions.

In one embodiment, an image capturing unit is further included, and is electrically connected to the smart identification module. An image of any one of the regions is captured by the image capturing unit, and the image is received and identified by the smart identification module whether the display element is present in the image. When the electronic display contents to be displayed in the region are determined from the image, if any part of the display element is blocked by an object, the smart identification module identifies a non-display range in which the display element is blocked by the object from the image, identifies a displayable range in which the display element is not blocked by the object from the image, and automatically displays the electronic display contents in the displayable range.

In one embodiment, a terminal device is further included. The terminal device is provided with the image capturing unit, and loads an application so as to be connected to the smart display unit. According to the displayable range and the non-display range identified by the smart identification module, when a predetermined position of the text and/or the pattern overlaps the non-display range, the smart display unit automatically adjusts the text and/or the pattern from the predetermined position to the displayable range by means of offsetting, rotating and/or scaling, and provides a preview of the adjusted electronic display contents in the state display region.

In one embodiment, the smart display unit further includes an environment detection module operable to detect environmental information of a location of the transportation vehicle in real time, and automatically adjusts all or a part of a background color of the electronic display contents on the display element according to the environmental information so as to provide a driving warning.

In one embodiment, the display element is electronic paper.

The present disclosure further provides a method of use of a smart display device displaying an appearance of a transportation vehicle. The method of use includes: connecting a smart display unit to a cloud server via the Internet, and returning a real-time position of the transportation vehicle to the cloud server; the cloud server receiving the real-time position of the transportation vehicle from the smart display unit, and searching for advertisement information of a merchant within a predetermined range by means of big data according to the real-time position; and displaying the advertisement information as the electronic display contents on the display element when the transportation vehicle travels through the predetermined range.

In one embodiment, the smart display unit, following the real-time position to update the advertisement information of the merchant within the predetermined range by the cloud server according to the direction of travel and the state of travel of the transportation vehicle.

In one embodiment, the display element is operable to separately display electronic display contents of different advertisement information at the first side portion, the second side portion and the vehicle rear portion, or the display element integrally displays electronic display contents of the same advertisement information at the first side portion, the second side portion and the vehicle rear portion.

In one embodiment, the advertisement information is at least one of

advertisement broadcast, brand promotion and commercial promotion; when the display element of the vehicle displays the advertisement information as the electronic display contents, at least one of a driven time, a region driven through and a driving mileage of the vehicle is calculated so as to calculate remuneration for displaying the advertisement information by the display element.

The present disclosure further provides a setting method of a smart display device displaying an appearance of a transportation vehicle, for an appearance of a vehicle body of the transportation vehicle to be customized and displayed in real-time. The smart display device includes a display element, a user interface and a smart display unit. The display element is disposed in multiple regions of the vehicle body along a contour of the vehicle body, and the display element and the user interface are electrically connected to the smart display unit. The setting method includes: a user pre-selecting one set of multiple sets of electronic display contents via the user interface, and displaying the same in a state display region of the user interface, each electronic display content includes a background, and a text and/or a pattern displayed in the background; operating a function display region of the user interface in the user interface to determine the background; operating the function display region in the user interface to determine the text and/or the pattern; displaying the determined background and the determined text and/or pattern in the state display region to provide a preview; and projecting the determined background and the determined text and/or pattern onto the display element for display.

In one embodiment, the setting method includes the smart display unit receiving a display signal according to a direction of travel, a real-time position and/or a state of travel of the transportation vehicle at a current timing from the transportation vehicle and/or an exterior, wherein the electronic display contents are contents corresponding to the direction of travel, the real-time position and/or the state of travel displayed by the display element in at least one of the regions according to the display signal.

In one embodiment, the setting method includes receiving the display signal by the image processing module, decoding/encoding the same to provide the electronic display contents to the display element, and identifying and differentiating a display range of the display element in each of the regions by the smart identification module.

In one embodiment, the setting method includes detecting environmental information of a location of the transportation vehicle in real time by the environment detection module, and the smart display unit automatically adjusting all or a part of a background color of the electronic display contents on the display element according to the environmental information so as to provide a driving warning.

In one embodiment, the setting method includes capturing an image of any one of the regions by the image capturing unit, receiving the image and identifying whether the display element is present in the image by the smart display unit, if any part of the display element is blocked by an object after the background and the text and/or the pattern is determined, identifying a binary black and white image with an image interference contour by means of edge detection and conversion, and the smart display unit identifying a non-display range in which the display element is blocked by the object from the binary black and white image and identifying a displayable range in which the display element is not blocked by the object from the image, wherein the electronic display contents are displayed only in the displayable range.

In one embodiment, the setting method includes, according to the displayable range and the non-display range identified by the smart display unit, when a predetermined position of the text and/or the pattern overlaps the non-display range, the smart display unit automatically adjusting the text and/or the pattern from the predetermined position to the displayable range by means of offsetting, rotating and/or scaling, and providing a preview of the adjusted electronic display contents in the state display region.

The present disclosure further provides a non-transitory computer-readable recording medium storing a plurality of executable codes for a smart display device to perform the methods above after the executable codes are read by the smart display device.

Thus, with the smart display device of the present disclosure and execution of the methods above, electronic display contents can be customized according to user requirements or preferences, so as to provide real-time display in multiple regions disposed on a vehicle body of a transportation vehicle. In addition to achieving an effect of quickly adjusting the appearance of the vehicle body of the transportation vehicle, designs of the appearance of the vehicle body of the transportation vehicle are also facilitated as being free from restrictions in terms of arrangement positions and volumes of physical lamps.

### BRIEF DESCRIPTION OF THE DRAWINGS

FIG. 1 is a system block diagram of a smart display device according to a specific embodiment of the present disclosure.

FIG. 2 is a schematic diagram of a transportation vehicle and a terminal device applied by a smart display device according to a specific embodiment of the present disclosure.

FIG. 3A is a flowchart of a setting method according to a specific embodiment of the present disclosure.

FIG. 3B is a flowchart of further determining whether a display element is blocked by an object in the setting method in FIG. 3A.

FIG. 4A is a schematic diagram of self-defined electronic display contents according to a specific embodiment of the present disclosure.

FIG. 4B is a schematic diagram of self-defined electronic display contents according to a specific embodiment of the present disclosure.

FIG. 4C is a schematic diagram of self-defined electronic display contents according to a specific embodiment of the present disclosure.

FIG. 5A is a schematic diagram of moving electronic display contents from a non-display range to a displayable range according to a specific embodiment of the present disclosure.

FIG. 5B is a schematic diagram of moving electronic display contents from a non-display range to a displayable range according to a specific embodiment of the present disclosure.

FIG. 5C is a schematic diagram of moving electronic display contents from a non-display range to a displayable range according to a specific embodiment of the present disclosure.

FIG. 5D is a schematic diagram of moving electronic display contents from a non-display range to a displayable range according to a specific embodiment of the present disclosure.

FIG. 6 is a schematic diagram of a transportation vehicle displaying an appearance according to self-defined electronic display contents according to a specific embodiment of the present disclosure.

FIG. 7 is a flowchart of a method of use according to a specific embodiment of the present disclosure.

FIG. 8 is a schematic diagram of a transportation vehicle communicating with a cloud server by a smart display device according to a specific embodiment of the present disclosure, wherein the map indicates a scenario of searching for advertisement information of a merchant within a predetermined range.

FIG. 9 is a schematic diagram of a transportation vehicle broadcasting advertisement information of a merchant within a predetermined range according to a specific embodiment of the present disclosure.

FIG. 10 is a schematic diagram of self-defined electronic display contents displayed on a display element at a vehicle rear portion of a transportation vehicle according to a specific embodiment of the present disclosure.

FIG. 11A is a schematic diagram of a taillight display mode, a direction light display mode and a roadblock display mode according to self-definition on a display element at a vehicle rear portion of a transportation vehicle according to a specific embodiment of the present disclosure.

FIG. 11B is a schematic diagram of a taillight display mode, a direction light display mode and a roadblock display mode according to self-definition on a display element at a vehicle rear portion of a transportation vehicle according to a specific embodiment of the present disclosure.

FIG. 11C is a schematic diagram of a taillight display mode, a direction light display mode and a roadblock display mode according to self-definition on a display element at a vehicle rear portion of a transportation vehicle according to a specific embodiment of the present disclosure.

FIG. 12 is a schematic diagram of a parking unit provided in a transportation vehicle according to a specific embodiment of the present disclosure, wherein the map shows an illustration of a smart display device receiving third-party data of real-time road conditions and map data.

FIG. 13 is a schematic diagram of keys and lamps displayed on a digital instrument panel of a transportation vehicle by a control module in FIG. 12.

FIG. 14A is a schematic diagram of operations of moving a stand from a parking position to a collapsed position according to a specific embodiment of the present disclosure.

FIG. 14B is a schematic diagram of operations of moving a stand from a parking position to a collapsed position according to a specific embodiment of the present disclosure.

FIG. 14C is a schematic diagram of operations of moving a stand from a parking position to a collapsed position according to a specific embodiment of the present disclosure.

FIG. 15A is a schematic diagram of operations of moving a stand from a collapsed position to a parking position according to a specific embodiment of the present disclosure.

FIG. 15B is a schematic diagram of operations of moving a stand from a collapsed position to a parking position according to a specific embodiment of the present disclosure.

FIG. 15C is a schematic diagram of operations of moving a stand from a collapsed position to a parking position according to a specific embodiment of the present disclosure.

### DETAILED DESCRIPTION OF THE INVENTION

To facilitate understanding of the object, characteristics and effects of the present disclosure, embodiments together with the attached drawings for the detailed description of the present disclosure are provided.

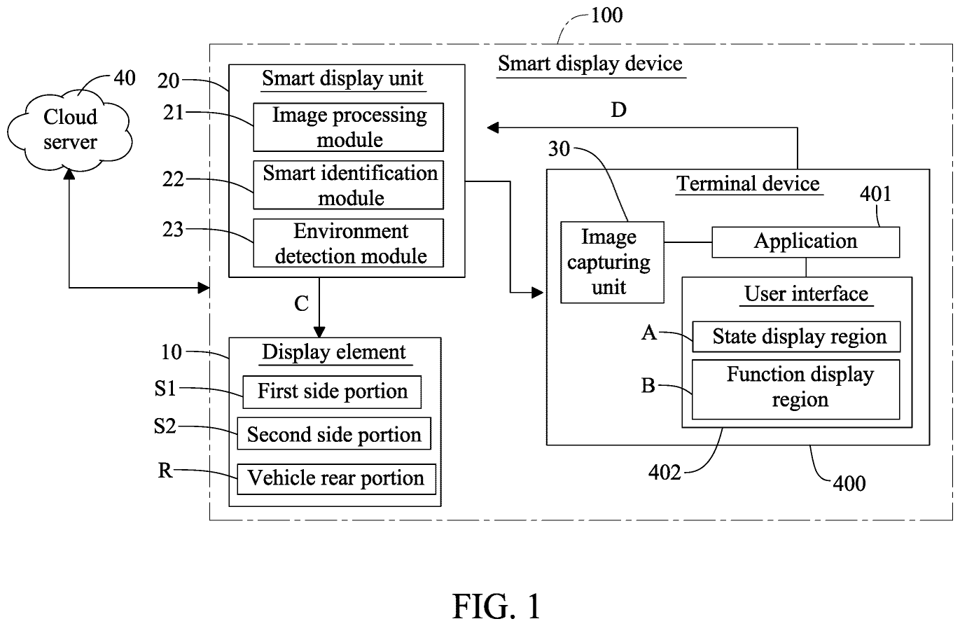

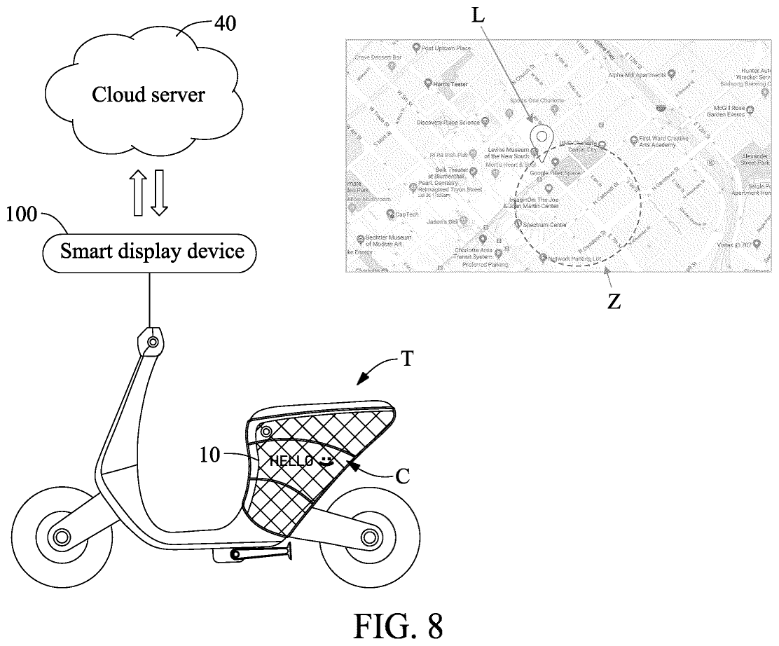

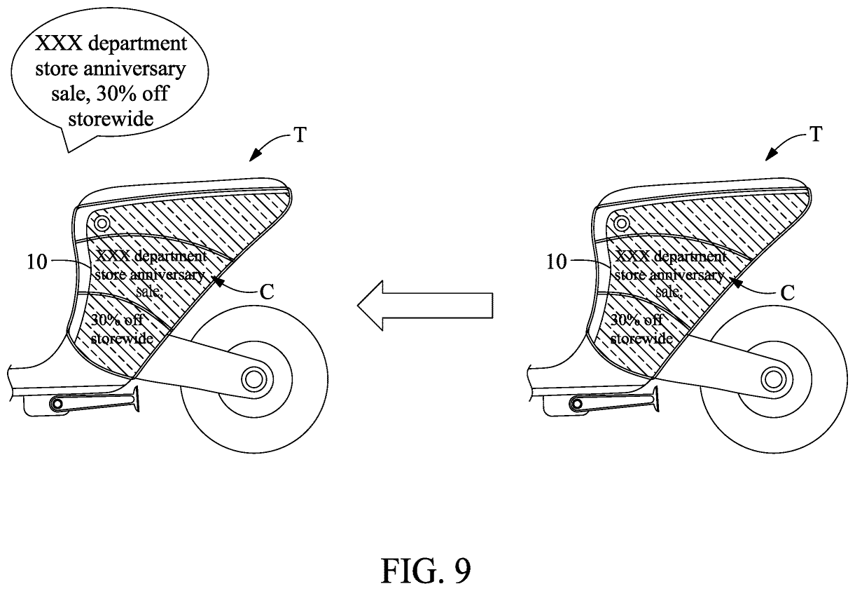

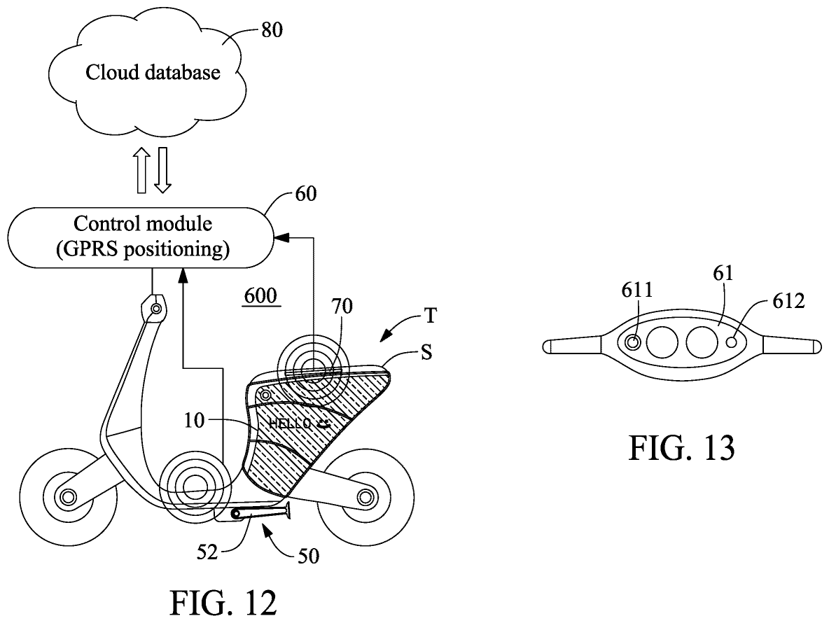

Referring to FIG. 1 to FIG. 15C, the present disclosure provides a smart display device 100 displaying an appearance of a transportation vehicle, a setting method 200 of the smart display device 100 and a method of use 300 of the smart display device 100. A motorcycle is taken as an example of a transportation vehicle T below; however, the transportation vehicle T of the present disclosure is not limited to the motorcycle, and any transportation vehicle used for transportation purposes, for example, land vehicles such as automobiles, aerial vehicles such as aircrafts and marine vehicles such as ships are also encompassed within the scope of the transportation vehicle T of the present disclosure.

Moreover, the transportation vehicle T referred to in the present disclosure can have a positioning function for transmitting a real-time position to an exterior, and the transportation vehicle T itself is not limited to necessarily having a positioning apparatus. For example, the transportation vehicle T can also be a transportation vehicle T without any positioning apparatus but coordinates with a terminal device 400 having a positioning function, or other apparatuses with a positioning function.

The terminal device 400 can be a device communicatively connectable to the smart display device 100 in a wired or wireless manner by the Internet, and is for example, a smartphone, a tablet computer or a laptop computer. As shown in FIG. 1, the terminal device 400 is mounted with an application 401, and executes the application 401 so as to be communicatively connected to the smart display device 100. The terminal device 400 provides a user interface 402 (for example, a cellphone screen) while executing the application 401, and a user can operate the user interface 402 in order to perform the method of use 300 or the setting method 200 above.

The smart display device 100 is disposed at the transportation vehicle T, and includes a display element 10, a user interface and a smart display unit 20. In one embodiment, the user interface is the user interface 402 of the terminal device 400; however, the present disclosure is not limited to the example above. The user interface can also be an instrument panel system integrated in a motorcycle, for example, a touch digital instrument panel, or an additionally provided operating interface. The display element 10 is disposed in multiple regions of a vehicle body of the transportation vehicle T along the contour of the vehicle body, and is electrically connected to the smart display unit 20. The smart display unit 20 provides the display element 10 with display contents. In one embodiment, the smart display unit 20 is communicatively connected to a driving system (not shown) of the transportation vehicle T, and the transportation vehicle T displays in real time display contents of the display element 10 thereof by the smart display unit 20.

In one embodiment, the display element 10 can be a display device attached along the vehicle body of the transportation vehicle T, and is, for example, generally known electronic paper disclosed by E-Ink Holdings Inc. In one embodiment, the vehicle body refers to sheet metal of a vehicle, and excludes glassware of a vehicle.

The user interface 402 includes a state display region A and a function display region B. The state display region A is operable to preview display contents of the display element 10, and the function display region B is operable to set the display contents of the display element 10, so that a user can define electronic display contents C in the function display region B according to preferences and preview the electronic display contents C in the state display region A in real time. The electronic display contents C of the present disclosure include a background, and a text and/or a pattern displayed in the background. The background can be in any color which can also be in a single color or a combination of different colors, and can be presented in a form such as a rendering effect (for example, gradient). The text and/or the pattern can be clearly displayed in the background, and is, for example, texts (including numerals and symbols), signs, illustrations or a combination thereof.

As described above, the smart display unit 20 is electrically connected to the display element 10 and the user interface 402, and is operable to further determine the electronic display contents C according to an operation of the user interface 402, display the electronic display contents C in real time on the display element 10, and use the electronic display contents C as the appearance of the vehicle body of the transportation vehicle T. In one embodiment, the smart display unit 20 includes an image processing module 21 and a smart identification module 22.

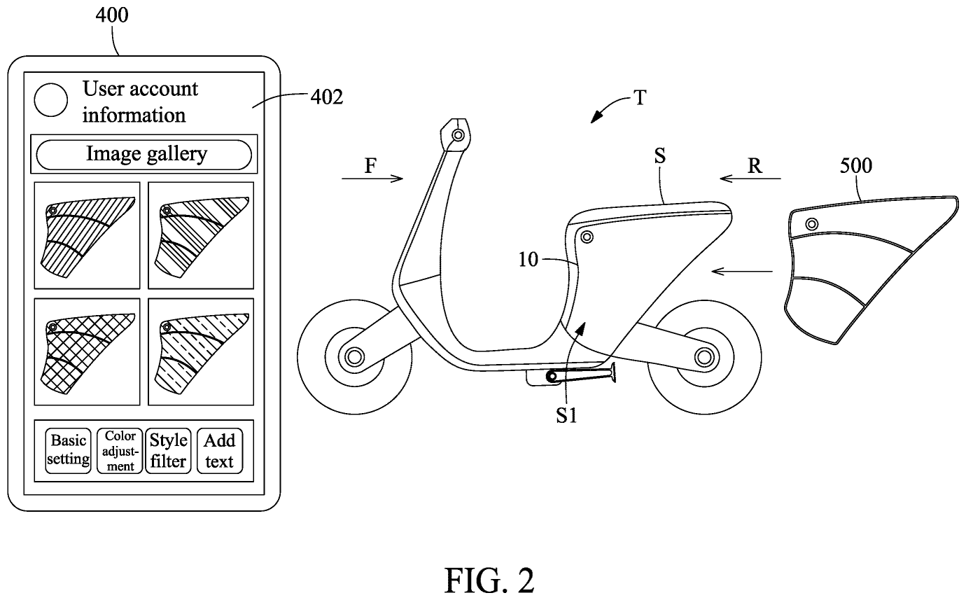

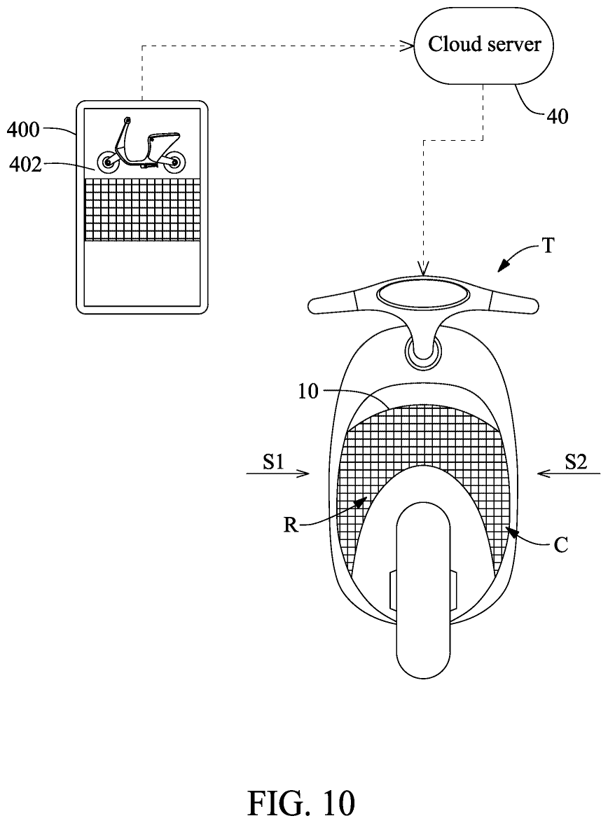

In one embodiment, the vehicle body of the transportation vehicle T is a body shell of a motorcycle, and the multiple regions include a vehicle front portion F, a first side portion S1, a second side portion S2 and a vehicle rear portion R of the vehicle body (referring to FIG. 2 and FIG. 10). In this embodiment, the display element 10 is multiple in quantity, and the multiple display elements 10 are disposed conformably along contours of the first side portion S1, the second side portion S2 and the vehicle rear portion R. In one embodiment, display ranges of the display elements 10 at the vehicle front portion F, the first side portion S1, the second side portion S2 and the vehicle rear portion R are identified and differentiated by the smart identification module 22, and the electronic display contents C can be displayed separately or displayed integrally at the first side portion S1, the second side portion S2 and the vehicle rear portion R. The “electronic display contents C can be displayed separately” means that the display elements 10 disposed at the first side portion S1, the second side portion S2 and the vehicle rear portion R individually display respective electronic display contents C. The “electronic display contents C can be displayed integrally” means that the display elements 10 disposed at the first side portion S1, the second side portion S2 and the vehicle rear portion R display one set of electronic display contents C as a whole as a video wall for advertisements. In one embodiment, the display element 10 can also be single in quantity and be an integral structure, which is disposed conformably along the contours of the first side portion S1, the second side portion S2 and the vehicle rear portion R.

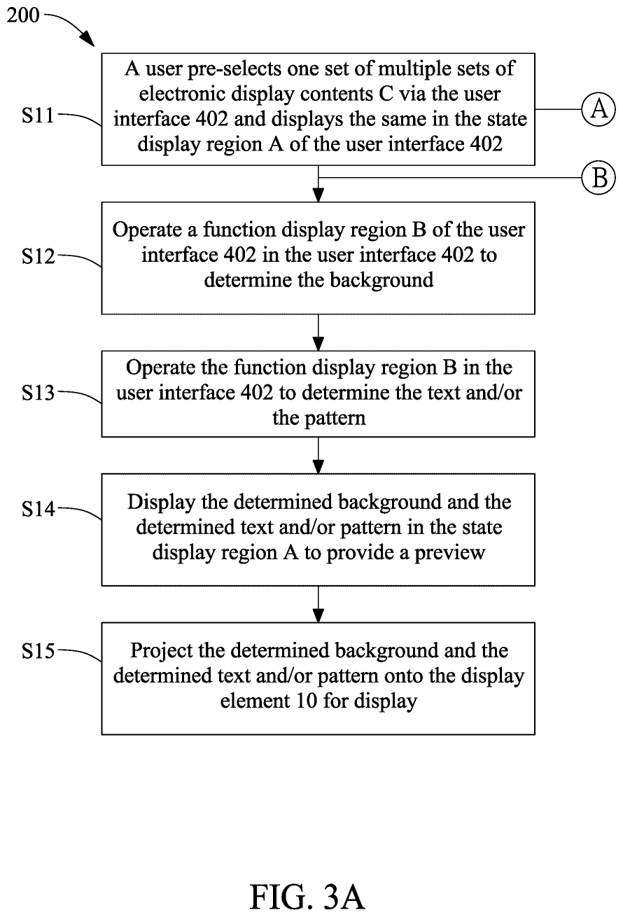

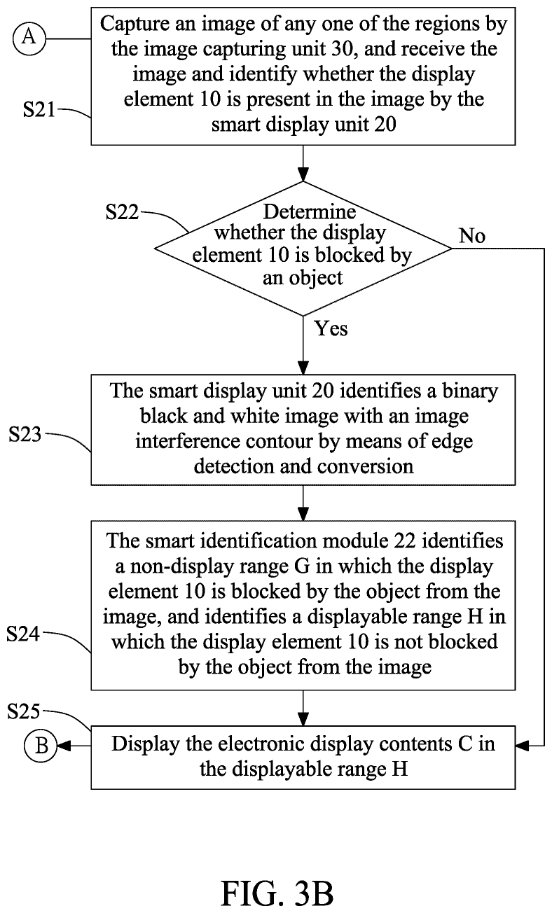

The setting method 200 is performed after the smart display device 100 reads the plurality of executable codes. As shown in FIG. 3A, the setting method 200 includes: a user pre-selecting one set of multiple sets of electronic display contents C via the user interface 402 and displaying the same in the state display region A of the user interface 402 (step S11); operating a function display region B of the user interface 402 in the user interface 402 to determine the background (step S12); operating the function display region B in the user interface 402 to determine the text and/or the pattern (step S13); displaying the determined background and the determined text and/or pattern in the state display region A to provide a preview (step S14); and projecting the determined background and the determined text and/or pattern onto the display element 10 for display (step S15). In one embodiment, the executable codes are stored in a non-transitory computer-readable recording medium, for example, stored as a program.

In one embodiment, the smart display device 100 further includes an image capturing unit 30 which is electrically connected to the smart identification module 22. As shown in FIG. 3B, the setting method 200 further includes: capturing an image of any one of the regions by the image capturing unit 30, and receiving the image and identifying whether the display element 10 is present in the image by the smart display unit 20 (step S21); further determining whether the display element 10 is blocked by an object (step S22); if a result of the determination is “yes”, the smart display unit 20 identifying a binary black and white image with an image interference contour by means of edge detection and conversion (step S23); the smart identification module 22 further identifying a non-display range G in which the display element 10 is blocked by the object from the image, and identifying a displayable range H in which the display element 10 is not blocked by the object from the image (step S24); and displaying the electronic display contents C in the displayable range H (step S25). If the result of the determination is “no”, it means that the display element 10 is not blocked by any object, the entire display element 10 at this point in time is regarded as the displayable range H, and step S25 is directly performed. In one embodiment, step S21 is performed after step S11 (as shown by a route A in FIG. 3A to FIG. 3B), and step S12 is performed after step S25 (as shown by a route B in FIG. 3A to FIG. 3B); however, the present disclosure is not limited to the sequence of the steps.

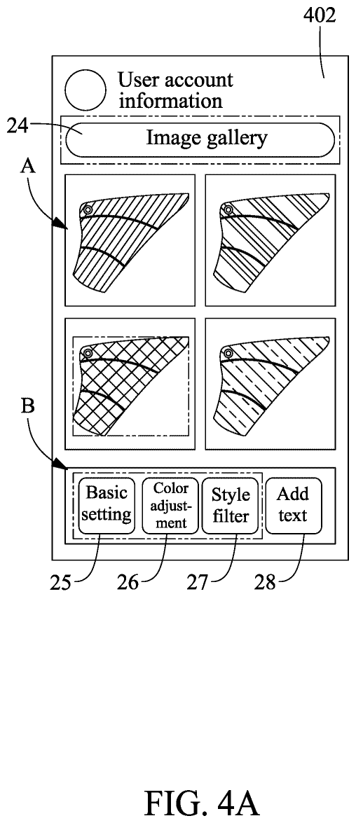

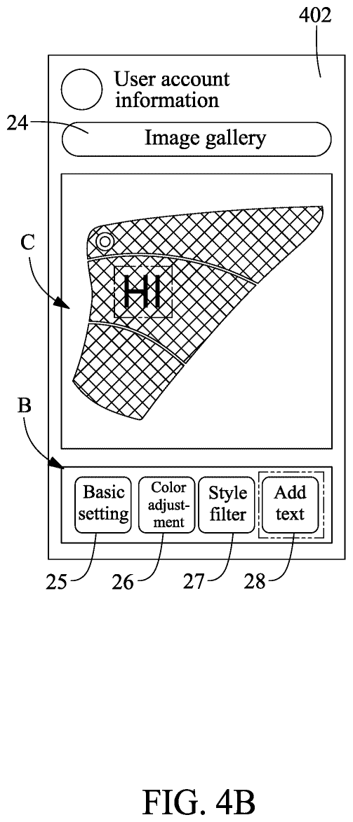

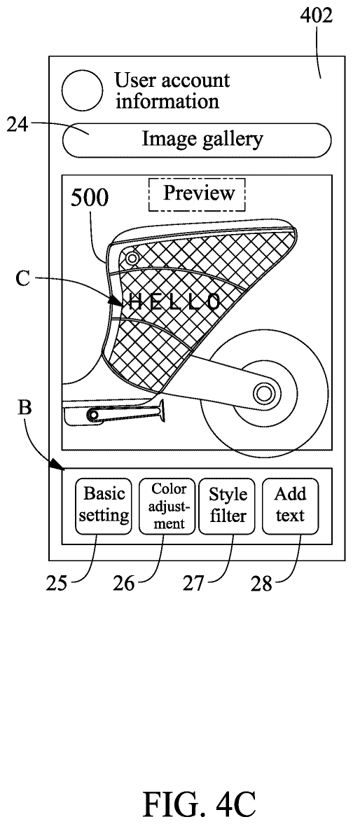

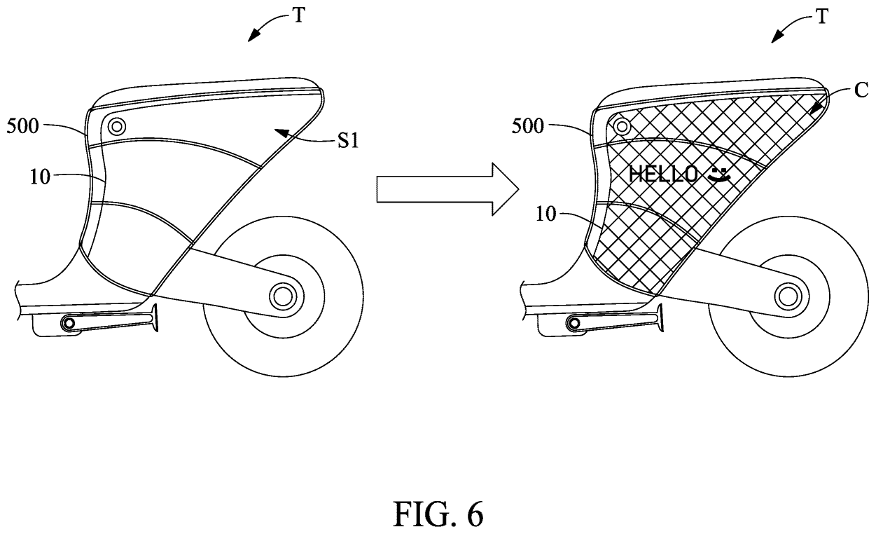

Step S11 can be performed by editing and selecting the text and/or pattern of the electronic display contents C via the user interface 402 by the user. As shown in FIG. 4A, the function display region B seen in the user interface 402 includes an option 24 of “image gallery”, an option 25 of “basic setting”, an option 26 of “color adjustment”, an option 27 of “style filter” and an option 28 of “add text”. The user can operate the user interface 402, for example, selecting the option 24 to display patterns of multiple predetermined backgrounds (for example, as shown in FIG. 4A) in the image gallery in the state display region A for the user to directly make the selection. Alternatively, the user can perform a selection operation on the option 25, the option 26 and the option 27 to perform personalized settings on any one of the predetermined backgrounds. The user can further perform the selection on the option 28 to add text to the background, wherein the text, for example, is “Hi” as a default (as shown in FIG. 4B) and then is edited by the user into “Hello”. A corresponding result can be previewed in real time in the state display region A (as shown in FIG. 4C), and the selected background and/or text is displayed on the display element 10 (as shown in FIG. 6).

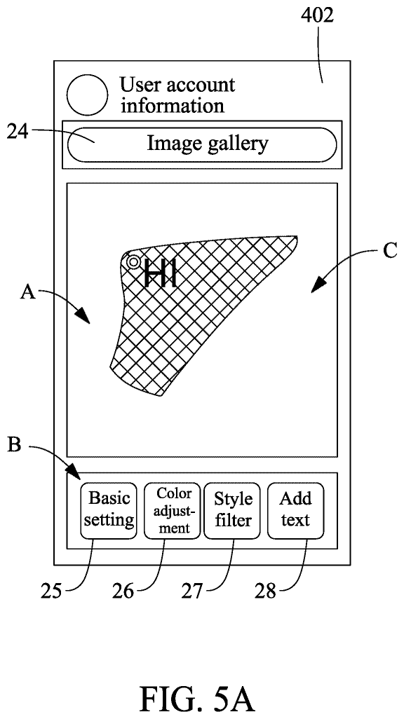

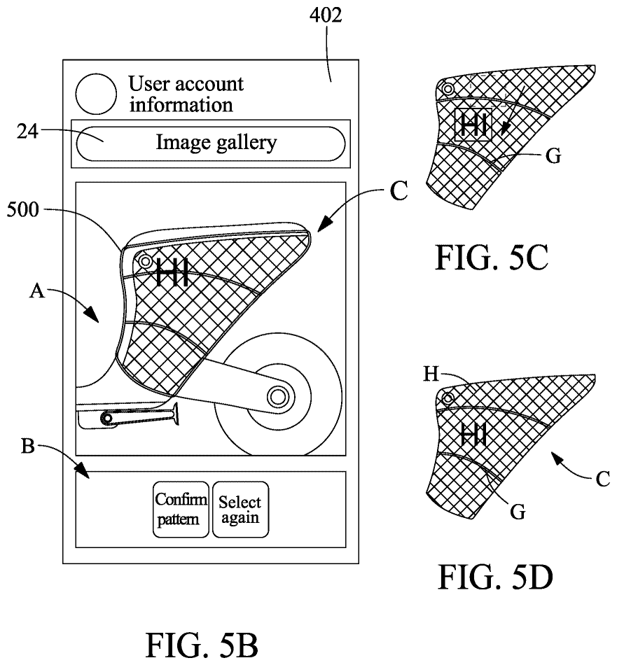

In one embodiment, as shown in FIG. 2, the transportation vehicle T is provided with the display element 10 at the first side portion S1, the object is a protective frame 500 arranged at the first side portion S1 to protect the display element 10, and the image capturing unit 30 is a camera of the terminal device 400. In step S21 performed after step S11, the user captures an image of the first side portion S1 by the image capturing unit 30, and the image is received by the smart identification module 22 to identify the display element 10 and the protective frame 500 disposed at the first side portion S1. When a result of determination after performing step S22 is “yes”, that is, the display element 10 is blocked by the protective frame 500, and the electronic display contents C on the display element 10 are displayed at a position overlapping the protective frame 500 as shown in a preview of the state display region A in FIG. 5B, step S23 and step S24 are then performed to identify an overlapping part between the protective frame 500 and the display element 10 as the non-display range G and a non-overlapping part as the displayable range H. Step S25 is then performed to automatically shift the electronic display contents C from an original predetermined position by the image processing module 21 (as shown in FIG. 5C), so that the electronic display contents C are adjusted to be displayed in the displayable range H (as shown in FIG. 5D), and display of the adjusted electronic display contents C can also be previewed from the state display region A. In step S25 above, the means of automatically adjusting of the text and/or the pattern of the electronic display contents C from the pre determined position to the displayable range H can be implemented by an image editing function such as offsetting, rotating and/or scaling, and is not limited to shifting described in the embodiment.

Step S12 is performed after step S21 to step S25. In step S12, the function display region B is operated in the user interface 402, including selecting and editing of the option 24 to the option 27 above, so as to determine the background (also referring to FIG. 4A). In step S13 that is performed next, the function display region B is again operated in the user interface 402, for example, selecting and editing of the option 28 above, so as to determine the text and/or the pattern of the electronic display contents C (also referring to FIG. 4B). In step S14 that is performed next, the determined background and the determined text and/or pattern are displayed in the state display region A to provide a preview (also referring to FIG. 4C). In step S15 that is performed next, the determined background and the determined text and/or pattern are projected onto the display element 10 for display (as shown in FIG. 6), thereby completing the setting method 200 of displaying the appearance of the transportation vehicle T.

In one embodiment, the smart display unit 20 can receive a display signal D (referring to FIG. 1) according to a direction of travel, a real-time position and/or a state of travel of the transportation vehicle T at a current timing from the transportation vehicle T and/or an exterior, wherein the electronic display contents C are contents corresponding to the direction of travel, the real-time position and/or the state of travel displayed by the display element 10 in at least one of the regions according to the display signal D. In one embodiment, the display signal D is received by the image processing module 21, and is decoded/encoded to provide the electronic display contents C to the display element 10. In one embodiment, the exterior can be a cloud server 40, and the display signal D can be advertisement information of a merchant.

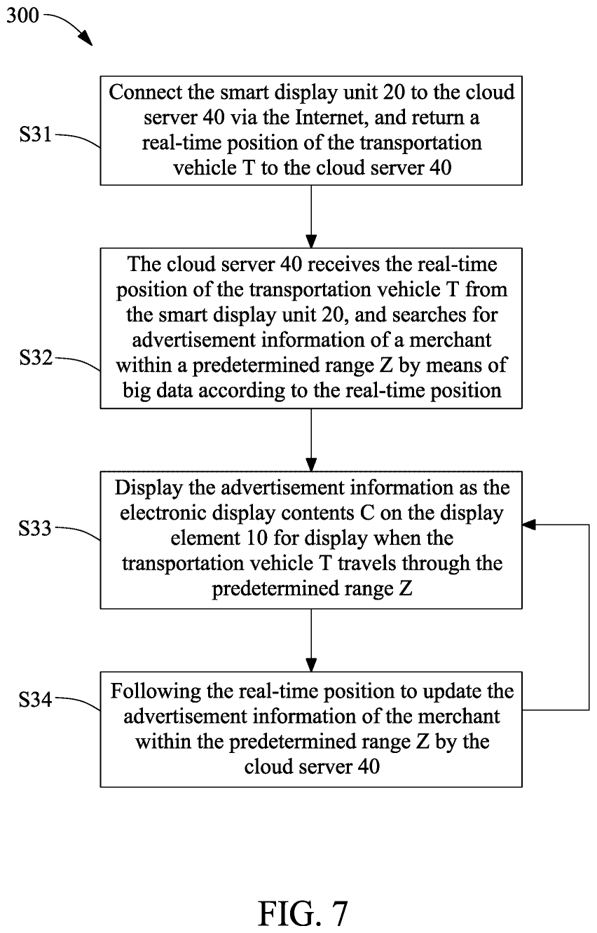

The method of use 300 is performed after the smart display device 100 reads a plurality of executable codes. As shown in FIG. 7 to FIG. 9, the method of use 300 includes: connecting the smart display unit 20 to the cloud server 40 via the Internet, and returning a real-time position of the transportation vehicle T to the cloud server 40 (step S31); the cloud server 40 receiving the real-time position of the transportation vehicle T from the smart display unit 20, and searching for advertisement information of a merchant within a predetermined range Z by means of big data according to the real-time position (step S32), wherein the advertisement information is at least one of advertisement broadcast, brand promotion and commercial promotion; and when the transportation vehicle T travels through the predetermined range Z, displaying the advertisement information as the electronic display contents C on the display element 10 for display (step S33), for example, displaying “XXX Department Store Anniversary sale; 30% Off Storewide” on the display element 10, or even perform voice playback with coordination of speakers (not shown). In one embodiment, the smart display unit 20, following the real-time position to update the advertisement information of the merchant within the predetermined range Z by the cloud server 40 according to the direction of travel and the state of travel of the transportation vehicle T (step S34).

Moreover, the electronic display contents C can be displayed separately as different advertisement information at the first side portion S1, the second side portion S2 and the vehicle rear portion R. In one embodiment, assume that the first side portion S1 faces other vehicles on the road, the second side portion S2 faces pedestrians on the sidewalk, and the vehicle rear portion R faces vehicles and pedestrians behind the transportation vehicle T. The electronic display contents C on the display element 10 at the first side portion S1 can be more relevant to drivers of the other vehicles, for example, “20% off on XXX brand engine oil maintenance”. The electronic display contents C on the display element 10 at the second side portion S2 can be relevant to any pedestrian, for example, “XXX department store anniversary sale; 30% off storewide”. The electronic display contents C on the display element 10 at the vehicle rear portion R can be relevant to drivers of the other vehicles and/or any pedestrian, for example, “20% off on XXX brand engine oil maintenance” and “XXX department store anniversary sale; 30% off storewide” displayed in turn. Thus, individuals facing in all directions of the display elements 10 can all obtain more relevant advertisement information from the electronic display contents C.

In continuation of the above, the present disclosure is not limited to having the display elements 10 in the individual regions separately display different advertisement information. The display elements 10 at the first side portion S1, the second side portion S2 and the vehicle rear portion R can also integrally display the same advertisement information, so that the display of the electronic display contents C can meet different utilization requirements of users. Moreover, when the display element 10 of the transportation vehicle T displays the advertisement information as the electronic display contents C, at least one of a driven time, a region driven by and a driving mileage of the transportation vehicle T is calculated so as to calculate remuneration for displaying the advertisement information by the display element 10. The merchant can accordingly provide a driver of the transportation vehicle T with a reward for broadcasting the advertisement information, and the driver can then acquire a corresponding reward, for example, cash or reimbursement of riding points.

In one embodiment, the smart display unit 20 further includes an environment detection module 23 (referring to FIG. 1); the setting method 200 further includes detecting environmental information of a location of the transportation vehicle T in real time by the environment detection module 23, and the smart display unit 20 automatically adjusting all or a part of a background color of the electronic display contents C on the display element 10 according to the environmental information so as to provide a driving warning. In one embodiment, the electronic display contents C are one or a combination of two or more of a color, a sign, a text and a pattern.

The environment detection module 23 includes, for example, a photosensitive resistor and a temperature sensor (not shown), wherein the photosensitive resistor is operable to detect brightness of an ambient environment of the location of the transportation vehicle T to determine whether it is a sunny or cloudy day. With further coordination of a humidity sensor operable to detect humidity of ambient environment of the location of the transportation vehicle T, it is further determined whether it is also raining, wherein the environmental information at this point in time is the brightness and the humidity. Thus, assuming that the background of the electronic display contents C of the display element 10 is originally in a light color (for example, pale yellow, pale blue or pink), when the environment detection module 23 detects that the brightness in the ambient environmental information is decreased or even when the humidity increases, and determines that the weather has changed from sunny to cloudy or rainy, the smart display unit 20 at this point in time automatically adjusts the background of the electronic display contents C to a bright color (for example, bright yellow, bright blue or bright red) according to the detected environmental information, so as to achieve an effect of warning for other transportation vehicles T or individuals around. Moreover, the environment detection module 23 can further coordinate with a vehicle radar to detect a direction of an approaching vehicle, and can display a background in a bright color and/or display a warning sign by the display element 10 facing approaching vehicles to achieve a function of warning the approaching vehicles.

In one embodiment, a user can define the electronic display contents C for any display element 10 according to preferences. When the user intends to set or change the background of the electronic display contents C on the display element 10 at the vehicle rear portion R, a connection to the cloud server 40 can be established via the Internet by the terminal device 400, and a preferred background, (for example, a grid pattern shown in FIG. 10) can be selected via the user interface 402. The cloud server 40 then provides the corresponding display signal D to the smart display unit 20 according to the display contents selected by the user, and the display element 10 at the vehicle rear portion R can then display an image of the grid pattern according to the display signal D.

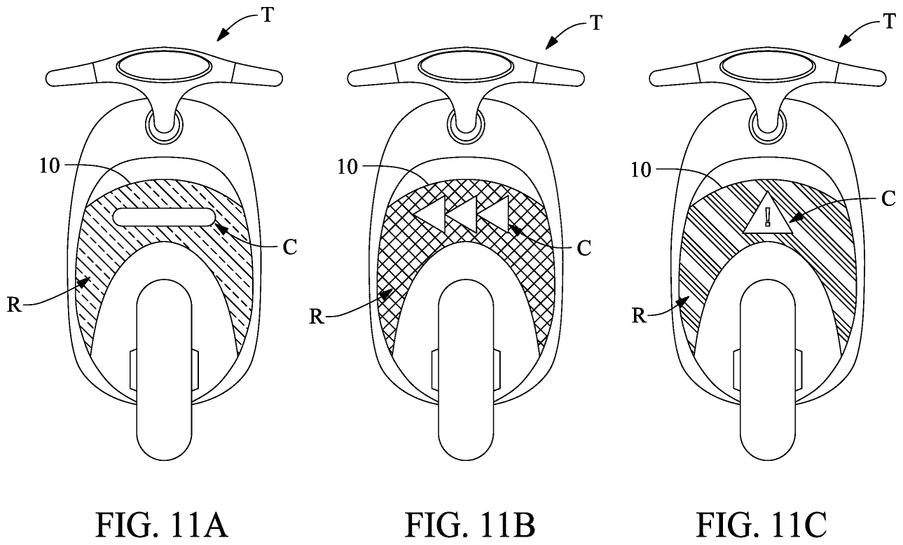

Moreover, the user can also define the text and/or the pattern of the electronic display contents C according to the direction of travel and the state of travel of the transportation vehicle T, for example, taillight display for warning during driving, direction light display for indicating directions, and roadblock display for warning in the event of a breakdown. The user can accordingly set a preferred taillight display mode, a direction light display mode and a roadblock display mode via the user interface 402 of the terminal device 400, and the cloud server 40 then provides the corresponding display signal D to the smart display unit 20. Thus, the display element 10 at the rear vehicle portion R performs display according to the setting of the user, for example, displaying the striped taillight as shown in FIG. 11A in the taillight display mode during the travel of the transportation vehicle T, displaying direction indication lights in three flashing triangular signs arranged side by side as shown in FIG. 11B in the direction light display mode if the direction of travel changes, or displaying the roadblock signal light in a triangular sign containing an exclamation mark and the background in red as a warning color as shown in FIG. 11C in the roadblock display mode if the vehicle breaks down. It is learned that, the background, text and/or pattern of the electronic display contents C can be customized according to user requirements or preferences and be displayed in real time.

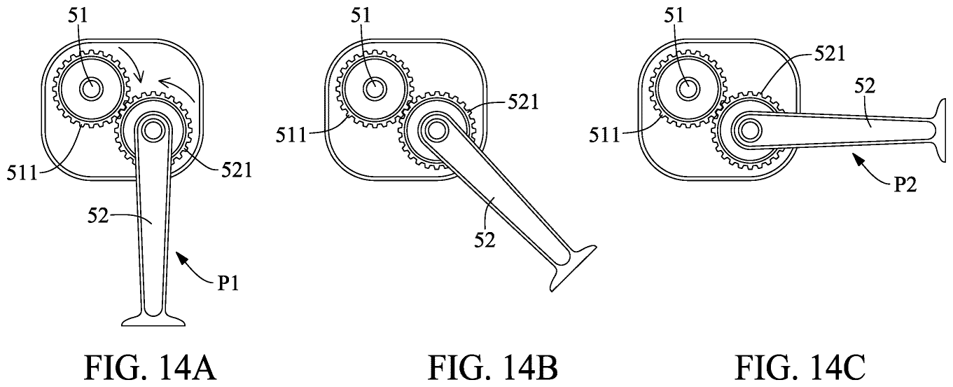

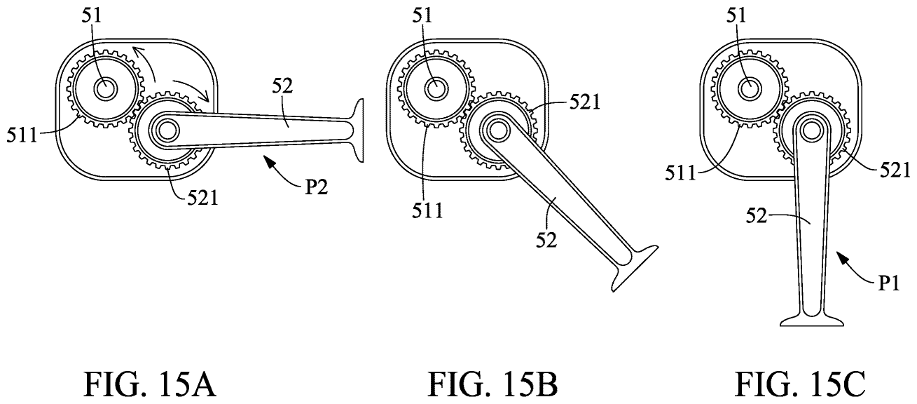

In one embodiment, as shown in FIG. 13, the transportation vehicle T is provided with a parking unit 600, which is operable for automatic parking and includes a stand module 50, a control module 60 and a weight sensor 70. As shown in FIG. 14A to FIG. 15C, the stand module 50 includes a driving member 51 and a stand 52. The driving member 51 is disposed at the transportation vehicle T, includes a first gear 511, and is operable to drive the first gear 511 to rotate. The stand 52 is pivotally disposed at the transportation vehicle T, and includes a second gear 521 for engaging with the first gear 511. By driving the first gear 511 to rotate by the driving member 51 to further drive the second gear 521 to rotate, the stand 52 can be moved between a parking position P1 at which the stand 52 is vertical and a collapsed position P2 at which the stand 52 is horizontal. In this embodiment, the control module 60 includes a digital instrument panel 61 of the transportation vehicle T, and is operable to perform General Packet Radio Service (GPRS) to position a real-time position (not shown) of the transportation vehicle T. The weight sensor 70 is disposed at a seat S of the transportation vehicle T, and is operable to detect a weight of the user.

During an operation, the parking unit 600 has a semi-automatic mode and a fully automatic mode. In the semi-automatic mode, when the transportation vehicle T is activated and a driving speed reduces to a predetermined speed (for example, 3 km/hour), the control module 60 determines that a parking condition is satisfied and a reminder notification (for example, displayed by a light 611) for parking is displayed on the digital instrument panel 61. At this point in time, if the user decides to support the transportation vehicle T by the stand 52, activation can be triggered by clicking a control key 612 on the digital instrument panel 61, and the control module 60 then issues a control signal to drive the driving member 51. With engagement and rotation of the first gear 511 and the second gear 521, the stand 52 is moved to the parking position P1 (as shown in FIG. 14A to FIG. 14C). Conversely, when the user again clicks the control key 612 on the digital instrument panel 61, the stand 52 can be collapsed to the collapsed position P2, and the transportation vehicle T then becomes in a drivable state (as shown in FIG. 15A to FIG. 15C).

In the fully automatic mode, the control module 60 is communicatively connected to a cloud database 80 and can thus download third-party data such as real-time road conditions and map data. The control module 60 determines the location and the speed of driving of the transportation vehicle T according to the positioned real-time position, and determines, in coordination with a weight change on the seat S detected by the weight sensor 70, whether the user is on the transportation vehicle T. Assume that the transportation vehicle T is originally in a still state and the stand 52 at this point in time is at the parking position P1. When the user sits on the seat S, the weight sensor 70 can detect the weight of the user, determines that the user is on the transportation vehicle T, and determines that a driving condition is satisfied after a predetermined period of time has elapsed. The control module 60 then automatically issues the control signal, such that the stand 52 is moved to the collapsed position P2 and the vehicle enters a state of travel. Moreover, when the transportation vehicle T returns to the still state from the driving state and the user leaves the seat S, the weight sensor 70 detects a weight change since the user has left, determines that the user has left the transportation vehicle T, and determines that the parking condition is satisfied after a predetermined period of time has elapsed. The control module 60 then automatically issues the control signal, such that the stand 52 is moved to the parking position P1.

In one embodiment, the transportation vehicle T can be installed with an element such as a speed sensor and a tilt sensor to detect the speed as well as motion posture and balance conditions of the transportation vehicle T, so as to assist in sensing the state of travel of the transportation vehicle T.

It is apparent from the above description that, the features of the present disclosure include the following: with the smart display device 100 and the execution of the setting method 200 and the method of use 300 of the present disclosure, the electronic display contents C displayed by the display element 10 can be customized according to user requirements or preferences, and can be displayed in real time by the display elements 10 disposed in multiple regions of the vehicle body of the transportation vehicle T. Thus, by displaying the electronic display contents C on the display element 10, in addition to achieving an effect of quickly adjusting the appearance of the vehicle body of the transportation vehicle T, designs of the appearance of the vehicle body of the transportation vehicle T are also facilitated as being free from restrictions in terms of arrangement positions and volumes of physical lamps.

In addition, regarding a stand of a current motorcycle, it is necessary to move and hence lower a collapsed stand by a foot of a user during parking, and then to tilt the vehicle body in order to allow the stand to support on the ground. However, such manual means for controlling the stand encounters various inconveniences during actual use, for example, the operation of stepping on the ground on a rainy day can easily lead to dangers due to the slippery ground. Moreover, if the user does not have a sufficient force to move the stand or when it is difficult for leg portions to excessively open for operation due to clothing (for example, when a short skirt is worn), collapsing and lowering the stand cannot be controlled with ease, further carelessly causing dangers in tilting of the motorcycle. With the parking unit 600 provided at the transportation vehicle T, the stand 52 can be collapsed or lowered with a one-key control in the semi-automatic mode, hence preventing various inconveniences caused by manually controlling the stand 52 during actual use as well as dangers in tilting of the motorcycle during manual operation, thereby achieving convenience and safety of operation. Moreover, in the fully automatic mode, the parking unit 600 can be further controlled by the control module 60 according to the state of travel so as to automatically control collapsing and lowering of the stand 52, for example, it is determined by artificial intelligence according to an operating state of the motorcycle in coordination with change timings of traffic signs whether to automatically collapse or lower the stand 52, without involving moving the stand 52 by a foot of the user or touching a key for control, thereby providing an inventive step.

The present disclosure is described by way of the preferred embodiments above. A person skilled in the art should understand that, these embodiments are merely for illustrating the present disclosure and are not to be construed as limitations to the scope of the present disclosure. It should be noted that all equivalent changes, replacements and substitutions made to the embodiments are encompassed within the scope of the present disclosure. Therefore. the legal protection for the present disclosure should be defined by the appended claims.

What is claimed is:

1. A smart display device displaying an appearance of a transportation vehicle, to allow an appearance of a vehicle body of the transportation vehicle to be customized and displayed in real time, the smart display device comprising:
a display element, disposed in a plurality of regions of the vehicle body along a contour of the vehicle body;
a user interface, comprising a state display region for previewing display contents and a function display region for setting the display contents, wherein a user defines electronic display contents in the function display region according to preferences, and previews the electronic display contents in real time in the state display region, and the electronic display contents comprise a background and a text and/or a pattern displayed in the background; and
a smart display unit, electrically connected to the display element and the user interface, the smart display unit operable to determine the electronic display contents according to an operation of the user interface so as to display the electronic display contents in real time on the display element as the appearance of the vehicle body.

2. The smart display device displaying an appearance of a transportation vehicle according to claim 1, wherein the transportation vehicle is a vehicle with two or more wheels, the vehicle body is a vehicle body of the vehicle, the plurality of regions comprise a vehicle front portion, a first side portion, a second side portion and a vehicle rear portion of the vehicle body, the display element is one or more and disposed conformably along contours of the first side portion, the second side portion and the vehicle rear portion, and the electronic display contents can be displayed separately or displayed integrally at the first side portion, the second side portion and/or the vehicle rear portion.

3. The smart display device displaying an appearance of a transportation vehicle according to claim 2, wherein the smart display unit receives a display signal according to a direction of travel, a real-time position and/or a state of travel of the transportation vehicle at a current timing from the transportation vehicle and/or an exterior, and the electronic display contents are contents corresponding to the direction of travel, the real-time position and/or the state of travel displayed by the display element in at least one of the regions according to the display signal.

4. The smart display device displaying an appearance of a transportation vehicle according to claim 3, wherein the smart display unit comprises an image processing module and a smart identification module, the image processing module is operable to receive the display signal and decode/encode the same to provide the electronic display contents to the display element, and the smart identification module is operable to identify and differentiate a display range of the display element in each of the regions.

5. The smart display device displaying an appearance of a transportation vehicle according to claim 4, further comprising:
an image capturing unit, electrically connected to the smart identification module;
wherein, an image of any one of the regions is captured by the image capturing unit, the image is received and identified by the smart identification module whether the display element is present in the image, if any part of the display element is blocked by an object after the electronic display contents to be displayed in the region are determined from the image, the smart identification module identifies a non-display range in which the display element is blocked by the object from the image, identifies a displayable range in which the display element is not blocked by the object from the image, and automatically displays the electronic display contents in the displayable range.

6. The smart display device displaying an appearance of a transportation vehicle according to claim 5, further comprising:
a terminal device, provided with the image capturing unit, the terminal device loading an application so as to be connected to the smart display unit;
wherein, according to the displayable range and the non-display range identified by the smart identification module, when a predetermined position of the text and/or the pattern overlaps the non-display range, the smart display unit automatically adjusts the text and/or the pattern from the predetermined position to the displayable range by means of offsetting, rotating and/or scaling, and provides a preview of the adjusted electronic display contents in the state display region.

7. The smart display device displaying an appearance of a transportation vehicle according to claim 4, wherein the smart display unit further comprises an environment detection module operable to detect environmental information of a location of the transportation vehicle in real time, and the smart display unit automatically adjusts all or a part of a background color of the electronic display contents on the display element according to the environmental information so as to provide a driving warning.

8. The smart display device displaying an appearance of a transportation vehicle according to claim 1, wherein the display element is electronic paper.

9. A method of use of a smart display device displaying an appearance of a transportation vehicle, to allow an appearance of a vehicle body of the transportation vehicle to be customized and displayed in real time, the method of use comprising:
connecting a smart display unit to a cloud server via the Internet, and returning a real-time position of the transportation vehicle to the cloud server;
the cloud server receiving the real-time position of the transportation vehicle by the smart display unit, and searching for advertisement information of a merchant within a predetermined range by means of big data according to the real-time position; and
when the transportation vehicle travels through the predetermined range, displaying the advertisement information as the electronic display contents on a display element disposed at the vehicle body.

10. The method of use of a smart display device according to claim 9, wherein the smart display unit, following the real-time position to update the advertisement information of the merchant within the predetermined range by the cloud server according to a direction of travel and a state of travel of the transportation vehicle.

11. The method of use of a smart display device according to claim 10, where in the transportation vehicle is a vehicle with two or more wheels, the vehicle body is a vehicle body of the vehicle, the vehicle body comprises a plurality of regions, the plurality of regions comprise a vehicle front portion, a first side portion, a second side portion and a vehicle rear portion, the display element is disposed at the first side portion, the second side portion and the vehicle rear portion and is operable to separately display the electronic display contents of different advertisement information, or the display element is disposed at the first side portion, the second side portion and the vehicle rear portion and is operable to integrally display the electronic display contents of the same advertisement information.

12. The method of use of a smart display device according to claim 11, wherein the advertisement information is at least one of advertisement broadcast, brand promotion and commercial promotion; when the display element of the vehicle displays the advertisement information as the electronic display contents, at least one of a driven time, a region driven through and a driving mileage of the vehicle is calculated so as to calculate remuneration for displaying the advertisement information by the display element.

13. A non-transitory computer-readable recording medium, storing a plurality of executable codes for a smart display device to perform the method of claim 9 after the executable codes are read by the smart display device.

14. A setting method of a smart display device displaying an appearance of a transportation vehicle, to allow an appearance of a vehicle body of the transportation vehicle to be customized and displayed in real time, the smart display device comprising a display element, a user interface and a smart display unit, the display element disposed in a plurality of regions of the vehicle body along a contour of the vehicle body, the display element and the user interface electrically connected to the smart display unit; the setting method comprising:
a user pre-selecting one set of a plurality of sets of electronic display contents via the user interface, and displaying the same in a state display region of the user interface, each electronic display content includes a background, and a text and/or a pattern displayed in the background;
operating a function display region of the user interface in the user interface to determine the background;
operating the function display region in the user interface to determine the text and/or the pattern;
displaying the determined background and the determined text and/or pattern in the state display region to provide a preview; and
projecting the determined background and the determined text and/or pattern onto the display element for display.

15. The setting method of a smart display device according to claim 14, further comprising:
the smart display unit receiving a display signal according to a direction of travel, a real-time position and/or a state of travel of the transportation vehicle at a current timing from the transportation vehicle and/or an exterior;
wherein, the electronic display contents are contents corresponding to the direction of travel, the real-time position and/or the state of travel displayed by the display element in at least one of the regions according to the display signal.

16. The setting method of a smart display device according to claim 15, wherein the smart display unit comprises an image processing module and a smart identification module; the setting method further comprises receiving the display signal by the image processing module, and decoding/encoding the same to provide the electronic display contents to the display element, and identifying and differentiating a display range of the display element in each of the regions by the smart identification module.

17. The setting method of a smart display device according to claim 16, wherein the smart display unit further comprises an environment detection module; the setting method further comprises detecting environmental information of a location of the transportation vehicle in real time by the environment detection module, and the smart display unit automatically adjusting all or a part of a background color of the electronic display contents on the display element according to the environmental information so as to provide a driving warning.

18. The setting method of a smart display device according to claim 14, further comprising:
capturing an image of any one of the regions by an image capturing unit of a terminal device;
receiving the image and identifying whether the display element is present in the image by the smart display unit;
if any part of the display element is blocked by an object after the background and the text and/or the pattern is determined, identifying a binary black and white image with an image interference contour by means of edge detection and conversion;
and the smart display unit identifying a non-display range in which the display element is blocked by the object from the binary black and white image and identifying a displayable range in which the display element is not blocked by the object from the image, wherein the electronic display contents are displayed only in the displayable range.

19. The setting method of a smart display device according to claim 18, wherein the terminal device loads an application so as to be connected to the smart display unit; and the setting method comprises, according to the displayable range and the non-display range identified by the smart display unit, when a predetermined position of the text and/or the pattern overlaps the non-display range, the smart display unit automatically adjusting the text and/or the pattern from the predetermined position to the displayable range by means of offsetting, rotating and/or scaling, and providing a preview of the adjusted electronic display contents in the state display region.

20. A non-transitory computer-readable recording medium, storing a plurality of executable codes for a smart display device to perform the method of claim 14 after the executable codes are read by the smart display device.
